(19) United States
(12) Patent Application Publication
(10) Pub. No.: US 2003/0086683 A1
(43) Pub. Date: May 8, 2003

(54) Information processing apparatus and reproduction processing control method

(76) Inventor: Toshikazu Morisawa, Tokorozawa-shi (JP)

Correspondence Address: Pillsbury Winthrop LLP, Suite 2800, 725 South Figueroa Street, Los Angeles, CA, 90017-5406, US

(21) Appl. No.: 10/235,138

(22) Filed: Sep. 4, 2002

(30) Foreign Application Priority Data
Nov. 6, 2001 (JP) 2001-340798

(51) Int. Cl. H04N 5/91

(52) U.S. Cl. 386/46

(57) ABSTRACT

A memory stores, as a common value, an audio and/or video set value for sound and/or video to be reproduced by reproduction application that is operable under the control of an operation system (OS), and for reproduction by a play module that is operable irrespective of the OS. If there is a change in the set value for the sound and/or video reproduced while the reproduction application is operating, a reflection module executes control so as to change the value, stored in the memory, to the changed set value. Furthermore, when the OS has been suspended or turned off and the play module has been activated, the play module executes sound and/or video reproduction using the set value stored in the memory.

### CROSS-REFERENCE TO RELATED APPLICATIONS

This application is based upon and claims the benefit of priority from the prior Japanese Patent Application No. 2001-340798, filed Nov. 6, 2001, the entire contents of which are incorporated herein by reference.

### BACKGROUND OF THE INVENTION

1. Field of the Invention

The present invention relates to an information processing apparatus having a sound or image reproduction function, and a reproduction processing control method for the same.

2. Description of the Related Art

In general, information processing apparatuses such as personal computers, mobile information devices, etc., have a function for reproducing, for example, music stored in, e.g., a CD-ROM, using an audio reproduction application (software) operable under the control of an OS (Operating System). Some information processing apparatuses have a function for reproducing, for example, music even if the OS is in a suspended state (i.e., a direct reproduction function).

The direct reproduction function is realized, for example, when a BIOS (Basic Input Output System) executes a certain code. In other words, this function is realized by software operable irrespective of the OS. Thus, the operating environment of the direct reproduction function significantly differs from that of the audio reproduction application.

Consideration will be given to a case where a user listens to music stored in, for example, a CD-ROM, using the audio reproduction application operable under the control of the OS. In this case, the user listens to the music with the volume set to a desired value. After the music has finished, the user shuts down the system (or makes the OS in a suspend state).

Thereafter, the user tries to listen to music using the direct reproduction function. At this time, however, the volume of to-be-reproduced music is forcibly set to an initial value for direct reproduction, irrespective of the value set by the user during the reproduction executed using the audio reproduction application. Accordingly, the user has to reset the volume of the to-be-reproduced music to a desired value, which is inconvenient.

This problem occurs when the user sets the sound quality or tone, as well as the volume. Moreover, it also occurs at the setting of an image.

### BRIEF SUMMARY OF THE INVENTION

Accordingly, it is an object of the present invention to provide an information processing apparatus and reproduction control method, in which a set value for the reproduction executed by a reproduction function is reflected to the reproduction executed by another reproduction function.

According to one aspect of the invention, there is provided an information processing apparatus capable of reproducing audio data, comprising a first reproduction processing unit capable of reproducing audio data while a main body of the information processing apparatus is operating; a second reproduction processing unit capable of reproducing audio data while the main body of the information processing apparatus is not operating; a memory to store a set value commonly used for reproduction of audio data executed by one of the first reproduction processing unit and the second reproduction processing unit; an updating unit capable of updating the set value stored in the memory while one of the first reproduction processing unit and the second reproduction processing unit is operating to reproduce audio data; and a reflection unit to copy an updated value to the memory as the set value if a change in the set value occurs during operation of the first reproduction processing unit, and to provide the set value to the first reproduction processing unit from the memory during initial operation of the first reproduction processing unit.

According to another aspect of the invention, there is provided an information processing apparatus capable of reproducing video data, comprising a first reproduction processing unit capable of reproducing video data while a main body of the information processing apparatus is operating; a second reproduction processing unit capable of reproducing video data while the main body of the information processing apparatus is not operating; a memory to store a set value commonly used for reproduction of video data executed by one of the first reproduction processing unit and the second reproduction processing unit; an updating unit capable of updating the set value stored in the memory while one of the first reproduction processing unit and the second reproduction processing unit is operating to reproduce video data; and a reflection unit to copy an updated value to the memory as the set value if a change in the set value occurs during operation of the first reproduction processing unit, and to provide the set value to the first reproduction processing unit from the memory during initial operation of the first reproduction processing unit.

According to still another aspect of the invention, there is provided a reproduction processing control method for use in an information processing apparatus capable of reproducing audio data, the method comprising reproducing audio data by a first reproduction processing unit while a main body of the information processing apparatus is operating; reproducing audio data by a second reproduction processing unit while the main body of the information processing apparatus is not operating; storing, in a memory, a set value commonly used for reproduction of audio data executed by one of the first reproduction processing unit and the second reproduction processing unit; enabling the set value stored in the memory to be updated while one of the first reproduction processing unit and the second reproduction processing unit is operating to reproduce audio data; and copying an updated value to the memory as the set value if a change in the set value occurs during operation of the first reproduction processing unit, and providing the set value to the first reproduction processing unit from the memory during initial operation of the first reproduction processing unit.

According to still another aspect of the invention, there is provided a reproduction processing control method for use in an information processing apparatus capable of reproducing video data, the method comprising reproducing video data by a first reproduction processing unit while a main body of the information processing apparatus is operating; reproducing video data by a second reproduction processing unit while the main body of the information processing apparatus is not operating; storing, in a memory, a set value commonly used for reproduction of video data executed by one of the first reproduction processing unit and the second reproduction processing unit; enabling the set value stored in the memory to be updated while one of the first reproduction processing unit and the second reproduction processing unit is operating to reproduce video data; and copying an updated value to the memory as the set value if a change in the set value occurs during operation of the first reproduction processing unit, and providing the set value to the first reproduction processing unit from the memory during initial operation of the first reproduction processing unit.

According to still another aspect of the invention, there is provided an information processing apparatus capable of reproducing at least one of audio data and video data, comprising a memory to store a set value used for reproduction of at least one of the audio data and the video data; a first reproduction processing unit operable while an operating system (OS) is operating, the first reproduction processing unit reproducing at least one of the audio data and the video data with reference to the set value stored in the memory; and a second reproduction processing unit operable when the OS is not operating, the second reproduction processing unit reproducing at least one of the audio data and the video data with reference to the set value stored in the memory.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the hardware structure of an information processing apparatus according to a first embodiment of the invention;

FIG. 2 is a block diagram useful in explaining software for realizing a reproduction processing control method for use in the apparatus of FIG. 1;

FIG. 3 is a flowchart useful in explaining the operation of the embodiment under the control of an OS;

FIG. 4 is a flowchart useful in explaining the operation of the embodiment using direct reproduction;

FIG. 5 is a block diagram illustrating the hardware structure of an information processing apparatus according to a second embodiment of the invention;

FIG. 6 is a flowchart useful in explaining the operation of the second embodiment under the control of an OS; and

FIG. 7 is a flowchart useful in explaining the operation of the second embodiment using direct reproduction.

### DETAILED DESCRIPTION OF THE INVENTION

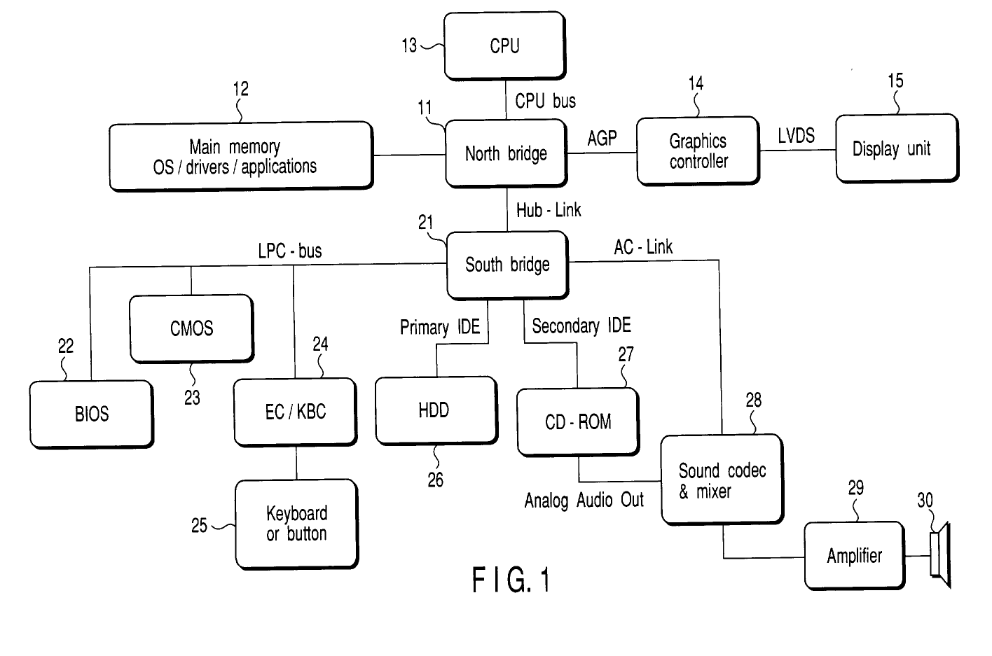

Embodiments of the present invention will be described below with reference to the drawings.

<First Embodiment>p FIG. 1 is a block diagram illustrating the hardware structure of an information processing apparatus according to a first embodiment of the invention.

A north bridge 11 includes various controllers for controlling bridging processing between a CPU 13 and south bridge 21, and controlling a main memory 21 and graphics controller 14, etc.

The main memory 12 stores an OS (Operating System), various drivers and applications, which are executed by the CPU 13, and serves as the work area of the CPU 13.

The CPU 13 is connected to the north bridge 11 via a CPU bus to control the entire information processing apparatus. For example, the CPU 13 executes, using the main memory 12, software for realizing the reproduction processing control method according to the invention.

The graphics controller 14 is connected to the north bridge 11 via an AGP (Accelerated Graphics Port) to control data to be displayed on a display unit 15.

The display unit 15 is connected to the graphics controller 14 via an LVDS (Low Voltage Differential Signaling) line, and can display, for example, a screen for an audio utility set by a user to change a value (e.g. a volume value) set when a sound or image is reproduced.

The south bridge 21 is connected to the north bridge 11 via a hub-link, and includes various controllers for controlling various devices on an LPC (Low Pin Count) bus, a disk drive corresponding to an IDE (Integrated Drive Electronics), an audio device connected via an AC (Audio Codec) link, etc.

A BIOS-ROM 22 is connected to the LPC bus, and stores a BIOS for mainly executing a setting process on the hardware in the apparatus when the apparatus is turned on. When executing the setting process, the BIOS uses setting information stored in a CMOS (Complementary Metal Oxide Semiconductor) memory 23.

The CMOS memory 23 is connected to the LPC bus, and stores various setting information items used by the BIOS. The setting information items include set values (e.g., a volume value) used to reproduce a sound or image.

An EC/KBC 24 is connected to the LPC bus to control buttons or a keyboard. The EC/KBC 24 is a combination of an EC (Embedded Controller) and a keyboard controller.

A keyboard or button 25 is used for user input. The user operates the keyboard or button (CD button) to start or stop reproduction of music stored in the CD-ROM, or to change the volume, etc.

A HDD (Hard Disk Drive) 26 is used as a device corresponding to a primary IDE and is connected to the south bridge 21. The HDD 26 drives a hard disk that stores various programs and data.

A CD-ROM drive 27 is used as a device corresponding to a secondary IDE and is connected to the south bridge 21. The drive 27 drives the CD-ROM that stores audio contents such as music.

A sound codec & mixer (hereinafter referred to simply as a “mixer”) 28 inputs an audio signal output from the CD-ROM drive 27, also inputs a control signal including a set value (e.g. a volume value) via the AC link connected to the south bridge 21, and outputs a sound signal corresponding to the control signal.

An amplifier 29 amplifies the sound signal from the mixer 28. A speaker 30 emits the sound signal amplified by the amplifier 29 as audible sound.

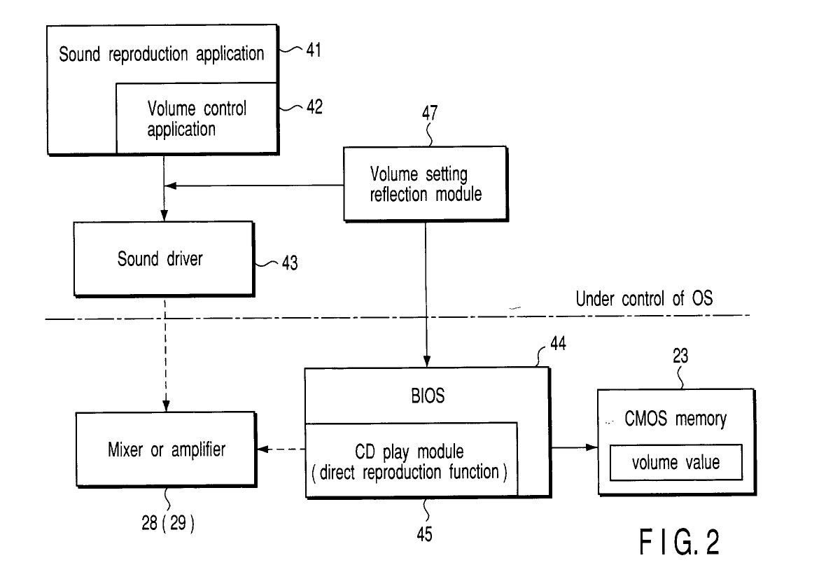

FIG. 2 is a block diagram useful in explaining software for realizing a reproduction processing control method according to the embodiment.

A sound reproduction application 41 is software that operates under the control of the OS to execute audio reproduction processing. In other words, the sound reproduction application 41 executes sound reproduction processing while the information processing apparatus is operating. The sound reproduction application 41 supplies a sound driver 43 with instructions for controlling the mixer 28 (or amplifier 29) as hardware. The user can change, on the setting screen of the display unit 15, various values set for reproduction executed by the sound reproduction application 41.

A volume control application 42 is included in the sound reproduction application 41 to execute volume control. The application 42 supplies a sound driver 43 with an instruction for controlling the volume of the mixer 28 (or amplifier 29) as hardware.

The sound driver 43 is software operable under the control of the OS and is dedicated to the control of the mixer 28 (or amplifier 29) as hardware. The sound driver 43 controls the mixer 28 (or amplifier 29) in accordance with instructions from the sound reproduction application 41 including the volume control application 42.

A BIOS 44 is the aforementioned BIOS stored in the BIOS-ROM 22. During the operation of the OS, the BIOS 44 writes the volume value, output from a volume setting reflection module 47, to the CMOS memory 23 in response to a request for writing it, and reads the volume value from the CMOS memory 23 in response to a request for reading it, thereby supplying it to the volume setting reflection module 47.

Further, the BIOS 44 includes a CD play module 45 for realizing a direct reproduction function. The CD play module 45 operates independently of the OS to directly control the mixer 28 (or amplifier 29) as hardware, thereby executing a sound reproduction process. In other words, the CD play module 45 executes a sound reproduction process when the main unit of the information processing apparatus does not operate.

Upon activation, the CD play module 45 reads the volume value from the CMOS memory 23 via the BIOS 44, and sets the read volume value in the mixer 28 (or amplifier 29).

The user can set and change the volume using the keyboard or button 25. If there is an instruction to set or change the volume via the keyboard or button 25 while the CD play module 45 is operating, the CD play module 45 sets, in the mixer 28 (or amplifier 29), a new volume value based on the instruction, and changes the volume value in the CMOS memory 23 to the new value.

The volume setting reflection module 47 is software that continuously operates under the control of the OS, and enables the volume value used in a reproduction process executed by the sound reproduction application 41, to be also used in a reproduction process executed by the CD play module 45 (or vice versa).

Upon activation, the volume setting reflection module 47 instructs the BIOS 44 to read the volume value from the CMOS memory 23, and also instructs the sound driver 43 to set the read volume value in the mixer 28 (or amplifier 29).

The user can set and change, on the setting screen of the display unit 15, the volume value controlled by the volume control application 42. If there is an instruction to set or change the volume value when the sound reproduction application 41 (and volume control application 42) is operating, the volume setting reflection module 47 instructs the BIOS 44 to change the volume value in the CMOS memory 23 to the new value indicated by the instruction.

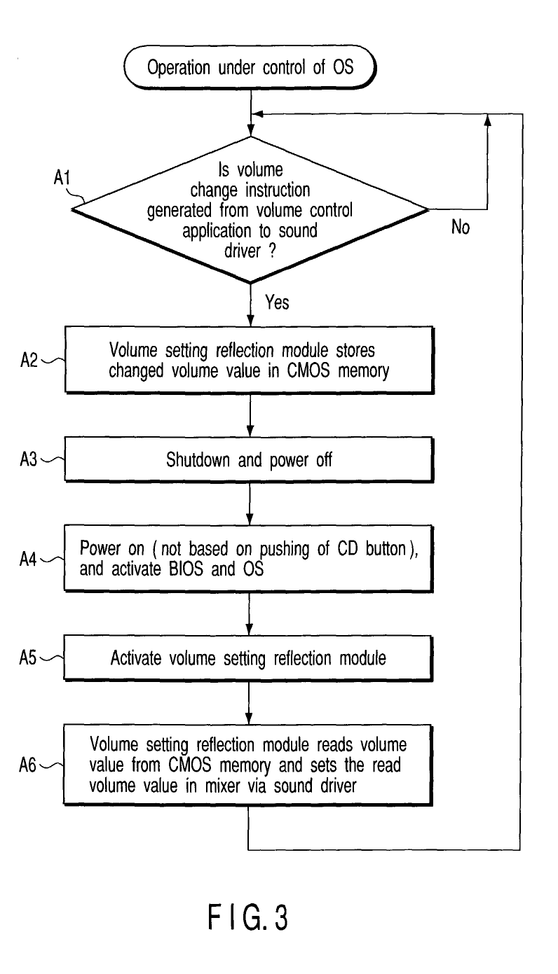

Referring to FIG. 3, a description will be given of the operation executed in the embodiment under the control of the OS.

When the OS is operating, the volume control on the mixer 28 (or amplifier 29) is executed by the volume control application 42 via the sound driver 43.

The volume setting reflection module 47 monitors volume change instructions sent from the volume control application 42 to the sound driver 43 (step A1).

When a volume change instruction has been issued from the volume control application 42 to the sound driver 43, the volume setting reflection module 47 instructs the BIOS 44 to store, in the CMOS memory 23, the new volume value indicated by the instruction (i.e., the module 47 overwrites the volume value stored in the CMOS memory 23) (step A2).

After that, the user finishes using the sound control application, shuts down the system (suspends the OS), and turns off the power supply (step A3).

The volume value stored in the CMOS memory 23 may be updated when the system is shut down.

When the power supply is again turned on, the BIOS 44 is activated, and the OS is also activated (the OS is activated unless the power supply is turned on by pushing the CD button) (step A4). Subsequently, the volume setting reflection module 47, which operates under the control of the OS, is activated (step A5).

Upon activation, the volume setting reflection module 47 starts initialization concerning volume setting. During this initialization, the volume setting reflection module 47 reads the volume value from the CMOS memory 23 via the BIOS 44, and executes control so as to set the read volume value in the mixer 28 (or amplifier 29) via the sound driver 43 (step A6). After that, the processing at the step A1 et seq. is repeated.

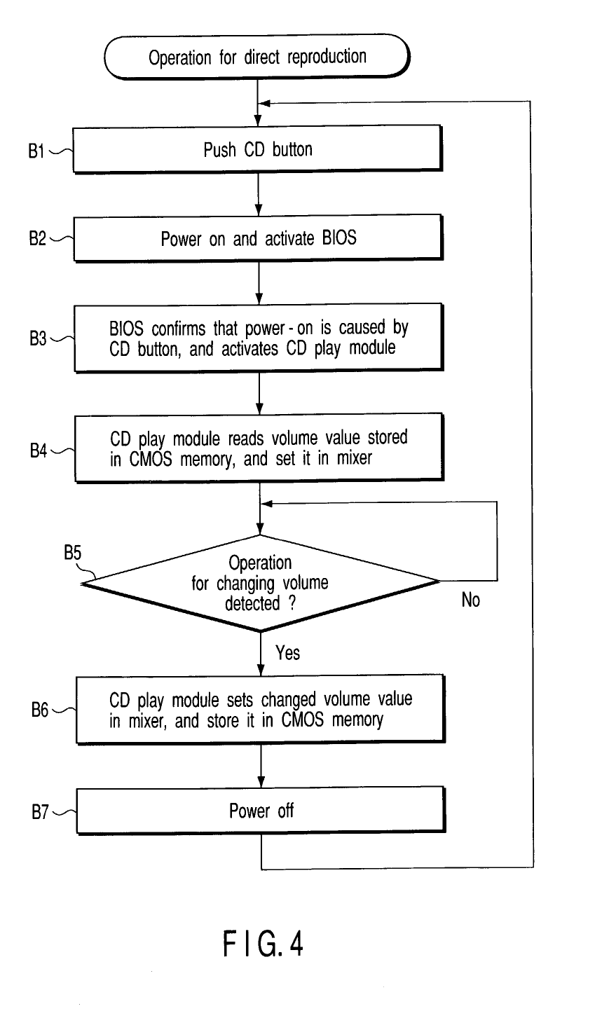

Referring now to FIG. 4, the direct reproduction operation executed in the embodiment will be described.

Where the system is shut down, if the embedded controller detects the pushing of the CD button (step B1), the power supply is turned on and the BIOS 44 is activated (step B2).

When the BIOS 44 has confirmed via the embedded controller that the pushing of the CD button has caused the power-on, it activates the CD play module 45 for realizing the direct reproduction function (step B3).

Upon activation, the CD play module 45 reads the volume value from the CMOS memory 23 via the BIOS 44, and sets the volume value in the mixer 28 (or amplifier 29) (step B4).

If the embedded controller detects a volume change instruction during the operation of the CD play module 45 (step B5), the CD play module 45 sets the new volume value, indicated by the instruction, in the mixer 28 (or amplifier 29), and executes control so as to store the new volume value in the CMOS memory 23 via the BIOS 44 (i.e., the module overwrites or updates the volume value stored in the CMOS memory 23) (step B6).

Then, the user finishes the use of the direct reproduction function and turns off the power supply (step B7). Thereafter, the processing at the step B1 et seq. is repeated.

The volume value in the CMOS memory 23 may be updated when the use of the direct reproduction function is finished.

As described above, in the first embodiment, control is executed so as to store a volume value in the CMOS memory 23, which is commonly set for the sound reproduced by the sound reproduction application 41 and CD play module 45. This means that the volume value set in a reproduction process executed by the sound reproduction application 41 is also used for a reproduction process executed by the CD play module 45. On the other hand, the volume value set in a reproduction process by the CD play module 45 can also be used for a reproduction process executed by the sound reproduction application 41.

<Second Embodiment>

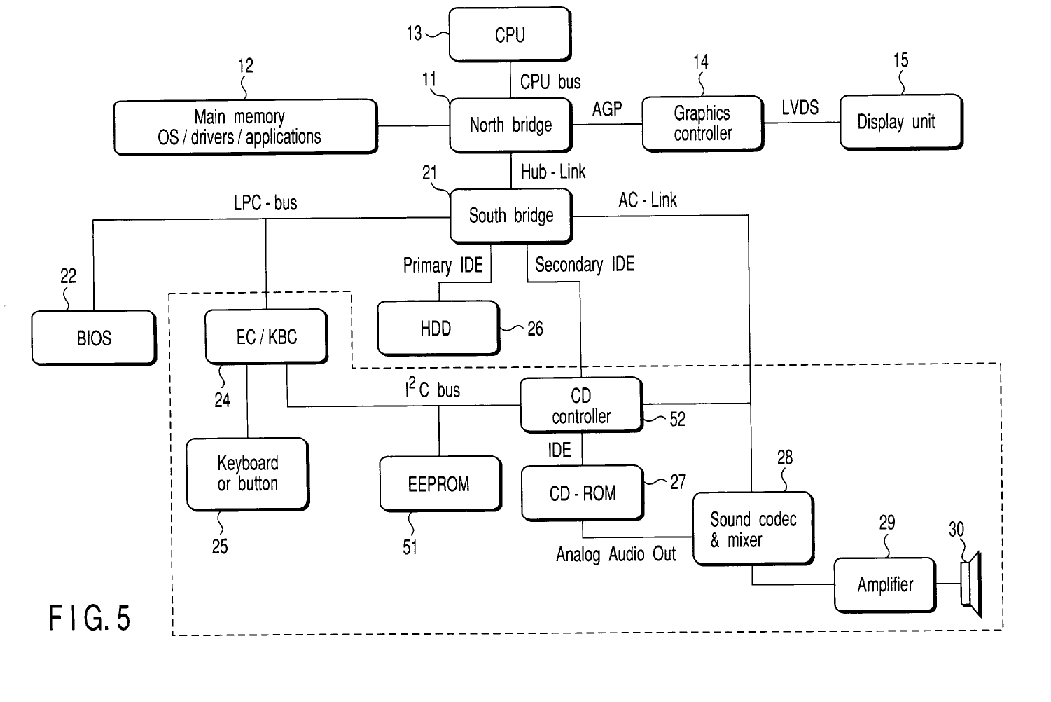

FIG. 5 is a block diagram illustrating the hardware structure of an information processing apparatus according to a second embodiment of the invention. In the first and second embodiments, like reference numeral denote like elements, to which no detailed description is given. Elements different from those in the first embodiment will be mainly described.

In the second embodiment, a CD controller 52 for controlling the CD-ROM 27 is interposed between the south bridge 21 and CD-ROM 27. The CD controller 52 is connected to the EC/KBC 24 via an Inter-IC (I²C) bus. The I²C bus is also connected to an EEPROM 51.

In the first embodiment, a set value of volume is stored in the CMOS memory 23. On the other hand, in the second embodiment, it is stored in the EEPROM 51. Further, in the first embodiment, reading/writing of the volume value from/to the CMOS memory 23 is executed via the BIOS 44, whereas in the second embodiment, reading/writing of the volume value from/to the EEPROM 51 is executed via the EC/KBC 24.

Also, in the first embodiment, the CD play module 45 is used to realize the direct reproduction function, while in the second embodiment, the CD controller 52 is used instead for the purpose. In other words, the CD controller 52 operates irrespective of the OS to directly control the mixer 28 (or amplifier 29) as hardware and execute a reproduction process.

Upon activation, the CD controller 52 reads the volume value from the EEPROM 51, and sets the read value in the mixer 28 (or amplifier 29). If there is an instruction to change the set volume during the operation of the CD controller 52, the CD controller 52 reads the contents of change in the instruction from the EC/KBC 24 via the I²C bus, thereby changing the volume value stored in the EEPROM 51 to the new value indicated by the instruction. This updating process may be executed when the use of the CD controller 52 is finished.

It is easy to understand the second embodiment as the EEPROM 51 and CD controller 52 replace the CMOS memory 23 and CD play module 45 (and BIOS 44), respectively.

Specifically, in the second embodiment, the volume setting reflection module 47 enables, in a reproduction process executed by the CD controller 52, the use of the volume value used in a reproduction process executed by the sound reproduction application 41 (or vice versa).

Upon activation, the volume setting reflection module 47 reads the volume value stored in the EEPROM 51, and instructs the sound driver 43 to set the read volume value in the mixer 28 (or amplifier 29).

Further, if there is an instruction to change the volume set for the sound that is being reproduced during the operation of the sound reproduction application 41, the volume setting reflection module 47 changes the volume value stored in the EEPROM 51 to the new value indicated by the instruction.

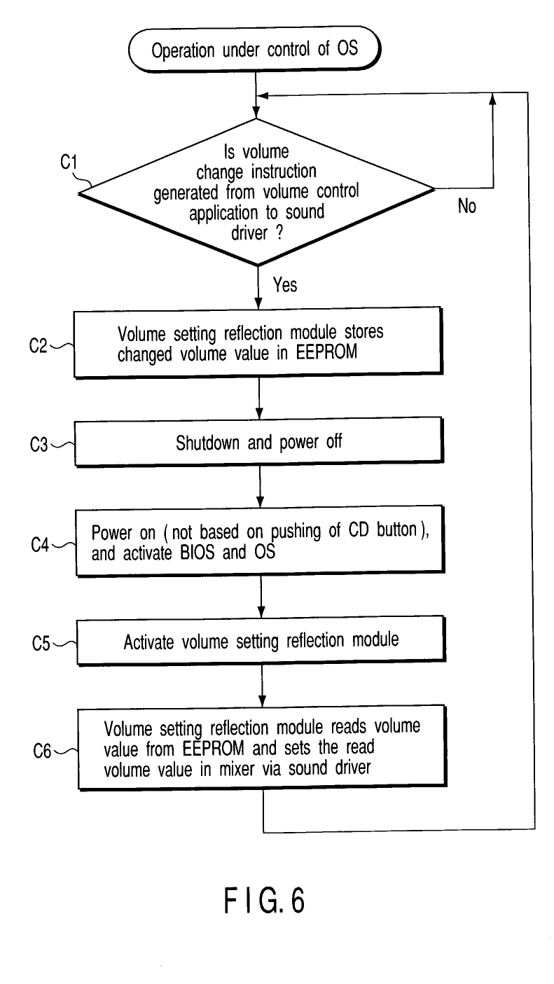

Referring then to FIG. 6, the operation of the second embodiment under the control of the OS will be described.

Under the control of the OS, the sound control application 42 executes sound control on the mixer 28 (or amplifier 29) via the sound driver 43.

The volume setting reflection module 47 monitors a volume change instruction from the volume control application 42 to the sound driver 43 (step C1).

When a volume change instruction has been issued from the volume control application 42 to the sound driver 43, the volume setting reflection module 47 executes control so as to store, in the EEPROM 51, the new volume value indicated by the instruction (i.e., the module 47 updates the volume value stored in the EEPROM 51) (step C2).

After that, the user finishes the use of the sound control application, shuts down the system (or suspends the OS), and turns off the power supply (step C3).

The volume value stored in the EEPROM 51 may be updated when the system is shut down.

When the power supply is again turned on, the BIOS 44 is activated, and the OS is also activated (the OS is activated unless the power supply is turned on by pushing the CD button) (step C4). Subsequently, the volume setting reflection module 47, which operates under the control of the OS, is activated (step C5).

Upon activation, the volume setting reflection module 47 starts initialization concerning volume setting. During the initialization, the volume setting reflection module 47 reads the volume value from the EEPROM 51, and executes control so as to set the read volume value in the mixer 28 (or amplifier 29) via the sound driver 43 (step C6). After that, the processing at the step C1 et seq. is repeated.

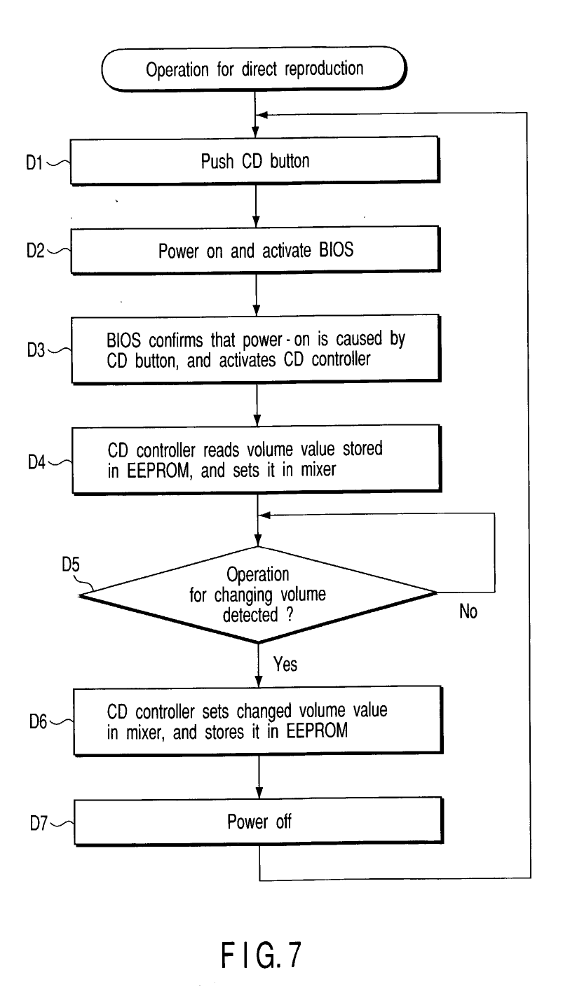

Referring to FIG. 7, the direct reproduction operation executed in the embodiment will be described.

Where the system is shut down, if the embedded controller detects the pushing of the CD button (step D1), the power supply is turned on and the BIOS 44 is activated (step D2).

When the BIOS 44 has confirmed via the embedded controller that the pushing of the CD button has caused the power-on, it activates the CD controller 52 for realizing the direct reproduction function (step D3).

Upon activation, the CD controller 52 reads the volume value from the EEPROM 51, and sets the volume value in the mixer 28 (or amplifier 29) (step D4).

If the embedded controller detects a volume change instruction during the operation of the CD controller 52 (step D5), the CD controller 52 sets the new volume value, indicated by the instruction, in the mixer 28 (or amplifier 29), and executes control so as to store the new volume value in the EEPROM 51 (i.e., the module overwrites or updates the volume value stored in the EEPROM 51) (step D6).

Then, the user finishes the use of the direct reproduction function and turns off the power supply (step D7). Thereafter, the processing at the step D1 et seq. is repeated.

The volume value in the EEPROM 51 may be updated when the use of the direct reproduction function is finished.

As described above, in the second embodiment, control is executed so as to store a volume value in the EEPROM 51, which is commonly set for the sound reproduced by the sound reproduction application 41 and CD controller 52. This means that the volume value set in a reproduction process executed by the sound reproduction application 41 is also used for a reproduction process executed by the CD controller 52. On the other hand, the volume value set in a reproduction process by the CD controller 52 can also be used for a reproduction process executed by the sound reproduction application 41.

The present invention is not limited to the above-described embodiments, but may be modified in various ways without departing from its scope.

For example, although the above embodiments use a volume value as a set value concerning sound, another set value (a sound quality value or a tone value, etc.) may be used.

Furthermore, although in the embodiments, a description has been given of a set value concerning sound, a set value concerning an image (a brightness, color number, resolution, etc.) may be used. In this case, a structure for reproducing sound and images stored in, for example, a DVD-ROM is employed instead of a structure for reproducing sound stored in a CD-ROM.

As described above in detail, the present invention can provide an information processing apparatus and reproduction control method, in which a set value for the reproduction executed by a reproduction function is reflected to the reproduction executed by another reproduction function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus capable of reproducing audio data, comprising:
a first reproduction processing unit capable of reproducing audio data while a main body of the information processing apparatus is operating;
a second reproduction processing unit capable of reproducing audio data while the main body of the information processing apparatus is not operating;
a memory to store a set value commonly used for reproduction of audio data executed by one of the first reproduction processing unit and the second reproduction processing unit;
an updating unit capable of updating the set value stored in the memory while one of the first reproduction processing unit and the second reproduction processing unit is operating to reproduce audio data; and
a reflection unit to copy an updated value to the memory as the set value if a change in the set value occurs during operation of the first reproduction processing unit, and to provide the set value to the first reproduction processing unit from the memory during initial operation of the first reproduction processing unit.

2. The apparatus according to claim 1, wherein the second reproduction processing unit operates under control of a BIOS (Basic Input/Output System).

3. The apparatus according to claim 1, wherein the set value is a value indicative of one of a volume, a sound quality, and a tone.

4. An information processing apparatus capable of reproducing video data, comprising:
a first reproduction processing unit capable of reproducing video data while a main body of the information processing apparatus is operating;
a second reproduction processing unit capable of reproducing video data while the main body of the information processing apparatus is not operating;
a memory to store a set value commonly used for reproduction of video data executed by one of the first reproduction processing unit and the second reproduction processing unit;
an updating unit capable of updating the set value stored in the memory while one of the first reproduction processing unit and the second reproduction processing unit is operating to reproduce video data; and
a reflection unit to copy an updated value to the memory as the set value if a change in the set value occurs during operation of the first reproduction processing unit, and to provide the set value to the first reproduction processing unit from the memory during initial operation of the first reproduction processing unit.

5. The apparatus according to claim 4, wherein the second reproduction processing unit operates under control of a BIOS (Basic Input/Output System).

6. The apparatus according to claim 4, wherein the set value is a value indicative of one of a brightness, a color number, and a resolution.

7. A reproduction processing control method for use in an information processing apparatus capable of reproducing audio data, the method comprising:
reproducing audio data by a first reproduction processing unit while a main body of the information processing apparatus is operating;
reproducing audio data by a second reproduction processing unit while the main body of the information processing apparatus is not operating;
storing, in a memory, a set value commonly used for reproduction of audio data executed by one of the first reproduction processing unit and the second reproduction processing unit;
enabling the set value stored in the memory to be updated while one of the first reproduction processing unit and the second reproduction processing unit is operating to reproduce audio data; and
copying an updated value to the memory as the set value if a change in the set value occurs during operation of the first reproduction processing unit, and providing the set value to the first reproduction processing unit from the memory during initial operation of the first reproduction processing unit.

8. A reproduction processing control method for use in an information processing apparatus capable of reproducing video data, the method comprising:
reproducing video data by a first reproduction processing unit while a main body of the information processing apparatus is operating;
reproducing video data by a second reproduction processing unit while the main body of the information processing apparatus is not operating;
storing, in a memory, a set value commonly used for reproduction of video data executed by one of the first reproduction processing unit and the second reproduction processing unit;
enabling the set value stored in the memory to be updated while one of the first reproduction processing unit and the second reproduction processing unit is operating to reproduce video data; and
copying an updated value to the memory as the set value if a change in the set value occurs during operation of the first reproduction processing unit, and providing the set value to the first reproduction processing unit from the memory during initial operation of the first reproduction processing unit.

9. An information processing apparatus capable of reproducing at least one of audio data and video data, comprising:
a memory to store a set value used for reproduction of at least one of the audio data and the video data;
a first reproduction processing unit operable while an operating system (OS) is operating, the first reproduction processing unit reproducing at least one of the audio data and the video data with reference to the set value stored in the memory; and
a second reproduction processing unit operable when the OS is not operating, the second reproduction processing unit reproducing at least one of the audio data and the video data with reference to the set value stored in the memory.

10. The apparatus according to claim 9, further including an updating unit that updates the set value stored in the memory, when a change in the set value occurs during a reproduction executed by one of the first reproduction processing unit and the second reproduction processing unit.

11. The apparatus according to claim 10, wherein the second reproduction processing unit executes reproduction of at least one of the audio data and the video data with reference to an updated value stored in the memory, when the change in the set occurs during the reproduction executed by the first reproduction processing unit and the set value stored in the memory has been updated.

12. The apparatus according to claim 10, wherein the first reproduction processing unit executes reproduction of at least one of the audio data and the video data with reference to an updated value stored in the memory, when the change in the set value occurs during the reproduction executed by the second reproduction processing unit and the set value stored in the memory has been updated.

13. An information processing apparatus capable of reproducing audio data, comprising:
a first reproduction processing unit capable of reproducing audio data when an operating system (OS) is operating;
a second reproduction processing unit capable of reproducing audio data when the OS is not operating;
a memory to store a set value commonly used for reproduction of audio data executed by one of the first reproduction processing unit and the second reproduction processing unit; and
a reflection unit to copy an updated value to the memory as the set value if a change in the set value occurs during operation of the first reproduction processing unit, and to provide the set value to the first reproduction processing unit from the memory during initial operation of the first reproduction processing unit.

14. The apparatus according to claim 13, wherein the second reproduction processing unit operates under control of a BIOS (Basic Input/Output System).

15. The apparatus according to claim 13, wherein the set value is a value indicative of one of a volume, a sound quality, and a tone.

16. A set value reflection module, comprising:
a machine-readable storage medium; and
machine-readable program code, stored on the machine-readable storage medium, having instructions to
receive an updated value from a reproduction processing unit, capable of reproducing audio data when an operating system (OS) is operating, if a change in a set value used for reproduction of audio data occurs during operation of the reproduction processing unit,
provide the updated value as the set value to a memory that stores the set value, and
provide the set value from the memory to the reproduction processing unit during initial operation of the reproduction processing unit.
